(19) United States
(12) Patent Application Publication
(10) Pub. No.: US 2012/0113557 A1
(43) Pub. Date: May 10, 2012

(54) ELECTRONIC CIRCUIT BREAKER

(75) Inventors: GÜNTER HENGELEIN, ALTDORF (DE); WOLFGANG SCHMIDT, BERG (DE)

(73) Assignee: ELLENBERGER & POENSGEN GMBH, ALTDORF (DE)

(21) Appl. No.: 13/329,665

(22) Filed: Dec. 19, 2011

Related U.S. Application Data
(63) Continuation of application No. PCT/EP2010/003362, filed on Jun. 2, 2010.

(30) Foreign Application Priority Data
Jun. 19, 2009 (DE) 10 2009 025 513.3

(51) Int. Cl. H01H 73/06

(52) U.S. Cl. 361/115

(57) ABSTRACT

A compact electronic circuit breaker is simple to assemble. The circuit breaker has an insulating housing, a switch contact for reversibly contacting a load power circuit to be monitored, a triggering magnet acting by way of a triggering mechanism on the switch contact, and triggering electronics for actuating the triggering magnet. The switch contact, the triggering magnet, and the triggering electronics are fixedly mounted on a printed circuit board and they form a preassembled component together with the printed circuit board. The preassembled component can thereby be inserted in the housing as a unit.

### CROSS-REFERENCE TO RELATED APPLICATION

This application is a continuation, under 35 U.S.C. §120, of copending international application No. PCT/EP2010/003362, filed Jun. 2, 2010, which designated the United States; this application also claims the priority, under 35 U.S.C. §119, of German patent application No. DE 10 2009 025 513.3, filed Jun. 19, 2009; the prior applications are herewith incorporated by reference in their entirety.

### BACKGROUND OF INVENTION

### Field of the Invention

The invention relates to an electronic circuit breaker. A circuit breaker such as this is used to automatically open an electrical load circuit when a tripping condition occurs, that is to say to electrically interrupt it. The tripping condition is normally an overcurrent (short circuit or overload). Additionally or alternatively, however, a circuit breaker may also be designed to trip in response to a different tripping condition, in particular an undervoltage or overvoltage.

In the case of traditional, electrical circuit breakers, the presence of the tripping condition is identified by a thermal and/or magnetic principle of operation. In general, thermal circuit breakers comprise a tripping element in the form of a bimetallic strip or expanding wire through which the load current flows and whose temperature-dependent shape change trips the circuit breaker. In the case of magnetic circuit breakers, tripping is generally carried out by the direct energizing of a solenoid coil by the load current itself. By way of example, one electrical overcurrent circuit breaker using the thermal tripping principle is known from commonly assigned U.S. Pat. No. 5,451,729 and its counterpart European patent EP 0 616 347 B1. A further electrical circuit breaker with additional undervoltage tripping is known from commonly assigned U.S. Pat. No. 5,834,996 and its counterpart European patent EP 0 802 552 B1.

In contrast to this, the tripping condition in an electronic circuit breaker is identified by an electronic circuit. The tripping electronics produce a tripping signal when a tripping condition is identified. The tripping signal then once again leads to the operation of, say, a magnetic release.

An electronic circuit breaker generally consists of a multiplicity of individual parts. On the one hand, it is therefore often comparatively difficult to produce in large quantities. On the other hand, an electronic circuit breaker can frequently be assembled only with a comparatively great amount of effort.

### SUMMARY OF THE INVENTION

It is accordingly an object of the invention to provide an electronic circuit breaker which overcomes the above-mentioned disadvantages of the heretofore-known devices and methods of this general type and which provides for a compact electronic circuit breaker which can be assembled easily.

With the foregoing and other objects in view there is provided, in accordance with the invention, an electronic circuit breaker, comprising:

an insulating housing;

a switching contact for reversible contact-making in a load circuit to be monitored;

a tripping magnet configured to act on said switching contact via a tripping mechanism;

tripping electronics for operation of said tripping magnet; and

a printed circuit board having firmly mounted thereon said switching contact, said tripping magnet, and said tripping electronics and forming therewith a preassembled assembly, with said preassembled assembly configured for insertion into, or inserted in, said housing as a unit.

In other words, the object of the invention is achieved by a circuit breaker assembly with an insulating housing, a switching contact for reversible contact-making, that is to say opening and closing of a load circuit to be monitored, a tripping magnet which acts on the switching contact via a tripping mechanism, as well as tripping electronics for operation of the tripping magnet. The switching contact, the tripping magnet and the tripping electronics are in this case firmly mounted on a common printed circuit board. The printed circuit board therefore forms a preassembled unit, or component unit, which could be preassembled in accordance with the requirements outside the circuit breaker housing and can be inserted as an entity into the housing during the course of final assembly of the circuit breaker. The preassembly of the switching contact, the tripping magnet and the tripping electronics on the common printed circuit board considerably simplifies the assembly effort for the circuit breaker overall. In this case, it should be noted in particular that the printed circuit board with the components to be mounted on this is considerably more accessible outside the circuit breaker housing than in the installed state, thus considerably simplifying manufacture of the preassembled assembly by machine, or half by machine. In particular, the components of the preassembled assembly can be completely electrically wired up outside the housing, by being mounted on the common printed circuit board. The electrical and electronic operation of the circuit breaker can in this way be tested even before the printed circuit board has been inserted into the housing, thus identifying production faults at an early stage, and avoiding consequential costs resulting from increased production scrap or subsequent repair of defective circuit breakers.

Furthermore, the preassembly of the switching contact, the tripping magnet and the tripping electronics on the common printed circuit board also allows a spatially particularly advantageous arrangement of these components, a system spatially particularly compact implementation of the circuit breaker.

In order to further simply assembly, contact rails are also preferably mounted firmly in advance on the printed circuit board within the preassembled assembly, and are used for the connection of the switching contact, of the tripping magnet and of the tripping electronics to external power lines, and which to this extent project out of the circuit breaker housing, in the final assembled state of the circuit breaker. The preassembled assembly in this embodiment advantageously contains all of the parts of the circuit breaker which carry current and/or voltage, thus reducing the final assembly of the circuit breaker to purely mechanical manufacturing steps.

Both with respect to simple assembly capability and with respect to a spatially particularly advantageous arrangement, because it is compact, of the circuit breaker components, in one preferred embodiment of the circuit breaker, the housing is formed essentially by a housing trough and a housing cover which can be fitted to the latter, with the printed circuit board, together with the parts already fitted to it, being held approximately parallel to the housing cover in the circuit breaker housing in the final assembled state. In the final assembled state, the printed circuit board is in this case expediently immediately adjacent to the housing cover. All further functional parts of the circuit breaker, in particular the moving parts of the tripping mechanism, are thus arranged in the interior of the housing trough, on the side of the printed circuit board facing away from the housing cover, in the final assembled state.

In accordance with a preferred embodiment of the invention, the tripping magnet is a holding magnet. The tripping magnet is therefore coupled to the tripping mechanism such that it keeps the circuit breaker in an energized state in a non-tripped position. The circuit breaker is therefore tripped by deactivation or disconnection of the tripping magnet, and not by energizing it. The embodiment of the tripping magnet as a holding magnet allows this magnet to have comparatively small dimensions, not least because no active magnetic energy pulse need be applied to trip the circuit breaker. In fact, when the tripping magnet is in the form of a holding magnet, the circuit breaker trips as a consequence of an elastic resetting force of the tripping mechanism. The compact physical form of the tripping magnet, which is in the form of a holding magnet, advantageously furthermore contributes to reducing the physical size of the circuit breaker.

A further preferred embodiment of the circuit breaker, in which the longitudinal axis of the tripping magnet is aligned essentially at right angles to the movement direction of the switching contact during opening and closing, is also advantageous for achieving a particularly compact design. In addition or as an alternative to this, the longitudinal axis of the tripping magnet is aligned essentially at right angles to the longitudinal direction of the housing—once again in order to achieve a particularly compact design. In this case, the longitudinal direction of the housing is that direction in which the housing has its greatest extent. This is normally that direction which connects a housing front face to a housing rear face. In this case, the housing front face is that housing face on which a control element, in particular a control knob or a switching rocker, projects outward from the housing. The housing rear face is that housing face on which electrical contact can be made with the circuit breaker, that is to say on which, in particular, the contact rails described above project outward.

The circuit breaker is preferably an overcurrent circuit breaker, which trips when an overcurrent which exceeds a predetermined current threshold occurs. In one preferred embodiment, the circuit breaker in this case trips after different holding times, depending on the load. In one expedient refinement, the tripping electronics are in this case designed to disconnect after short holding times in the event of very high short-circuit currents, and to disconnect after longer holding times when lower overcurrents occur (overload). The tripping electronics preferably take account of the magnitude of the load current level for short-circuit tripping. In contrast, for overload tripping, the tripping electronics expediently take account of the square of the load current level as a measure of the electrical power of the load current. The tripping electronics are preferably subdivided once again into a number of disconnection steps, which each have different holding times depending on the load, for short-circuit tripping and/or overload tripping.

In addition or as an alternative to overcurrent tripping, in one preferred embodiment, the circuit breaker has an undervoltage tripping function and/or overvoltage tripping function. It is also possible to provide for the circuit breaker additionally or alternatively also to trip when some other, in particular thermal, tripping condition occurs.

In addition to single-pole embodiments, multipole embodiments of the circuit breaker according to the invention are also envisaged. These have a plurality of switching contacts, the number of which corresponds to the number of poles and which can be opened and closed simultaneously, reversibly, via coupled tripping mechanisms, in particular in a common housing. For economic production capability reasons, a separate printed circuit board is expediently provided for each pole within such multipole embodiments, on which printed circuit board the switching contact and respective tripping electronics, associated with this pole, are fitted in advance. Furthermore, the contact rails which are required for connection of the switching contact and of the tripping electronics to external power lines are optionally already fitted permanently in advance on each printed circuit board. In contrast, for reasons relating to weight, physical space and material saving—only one (a single one) of these printed circuit boards expediently has an associated tripping magnet, which acts on all the switching contacts via the coupled tripping mechanisms. The plurality of tripping electronics are in this case connected in parallel with the tripping magnet, for operating purposes.

Other features which are considered as characteristic for the invention are set forth in the appended claims.

Although the invention is illustrated and described herein as embodied in an electronic circuit breaker, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an exploded, perspective illustration of an electronic circuit breaker according to the invention;

FIG. 2 shows a section illustration of the circuit breaker in an OFF position;

FIG. 3 shows an illustration corresponding to FIG. 2 of the circuit breaker in an ON position, in the non-tripped state;

FIG. 4 shows an illustration corresponding to FIG. 2 of the circuit breaker in the ON position, but in the tripped state;

FIG. 5 is a sectional view of the circuit breaker taken along the line V-V in FIG. 2;

FIG. 6 shows a block diagram of operating electronics for operating the circuit breaker;

FIGS. 7 and 8 each show current/time graphs of the time profile of a control method, which is implemented in the operating electronics as shown in FIG. 6, for tripping the circuit breaker in the event of a short circuit or overload; and

FIG. 9 shows a time/current graph of two characteristics, which characterize the tripping behavior of the circuit breaker in the event of a short circuit or overload.

### DETAILED DESCRIPTION OF THE INVENTION

Like elements and parts, as well as functionally and structurally corresponding parts and variables are identified with the same reference symbols throughout the figures.

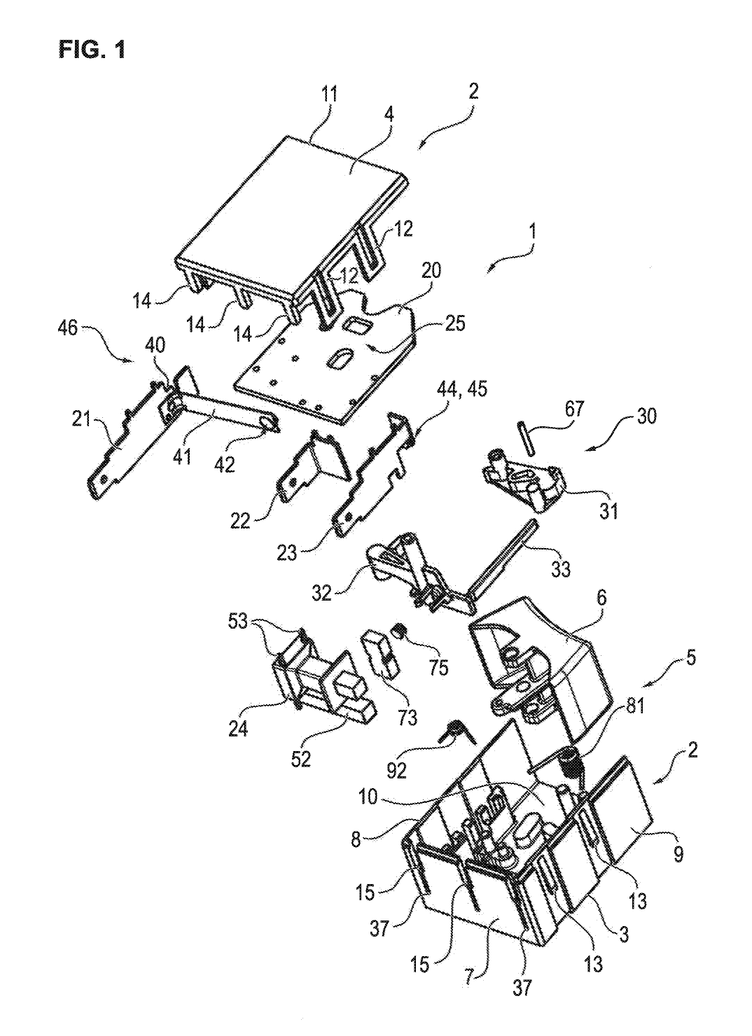

Referring now to the figures of the drawing in detail and first, particularly, to FIG. 1 thereof, there is shown an exploded illustration of an electronic circuit breaker 1. In this case, the circuit breaker 1 is in the form of an overcurrent circuit breaker. In addition, the circuit breaker 1 trips when a predetermined undervoltage threshold is undershot.

The circuit breaker 1 has a housing 2 composed of insulating plastic, which in turn has a housing trough 3 and a housing cover 4. The closed housing 2 is substantially in the form of a flat cuboid, which is closed on three narrow faces. In the assembled state, a switching rocker 6 which can be tilted for activation or deactivation of the circuit breaker 1 is used as a control element on the fourth narrow face, which is referred to in the following text as the front face 5. A narrow face of the housing 2 opposite the front face 5 is referred to in the following text as its rear wall 7. The two adjacent (mutually opposite) narrow faces of the housing 2 form its side walls 8 and 9.

The housing trough 3 is formed substantially by a housing base 10, the rear wall 7 and the side walls 8, 9, while the housing cover 4 is formed essentially by a rectangular plate 11, which is provided on the edges with latching eyes 12, which are integrally formed approximately at right angles, for latching to corresponding latching tabs 13 on the side walls 8 and 9. Furthermore, pins 14 which project at right angles and can be inserted into complementary slots 15 in the rear wall 7, such that they fit very accurately, are integrally formed on the plate 11, in the area of its edge which faces the rear wall 7.

The circuit breaker 1 furthermore has a printed circuit board 20 which is inserted into the housing 2 substantially parallel to the housing cover 4 in the assembled state.

Three electrical contact rails 21, 22 and 23, as well an electromagnet 24 which acts essentially as a tripping element for the circuit breaker 1, are soldered onto the printed circuit board 20. Furthermore, tripping electronics 25, which will not be described any further here, for operating the electromagnet 24 are arranged on the printed circuit board 20.

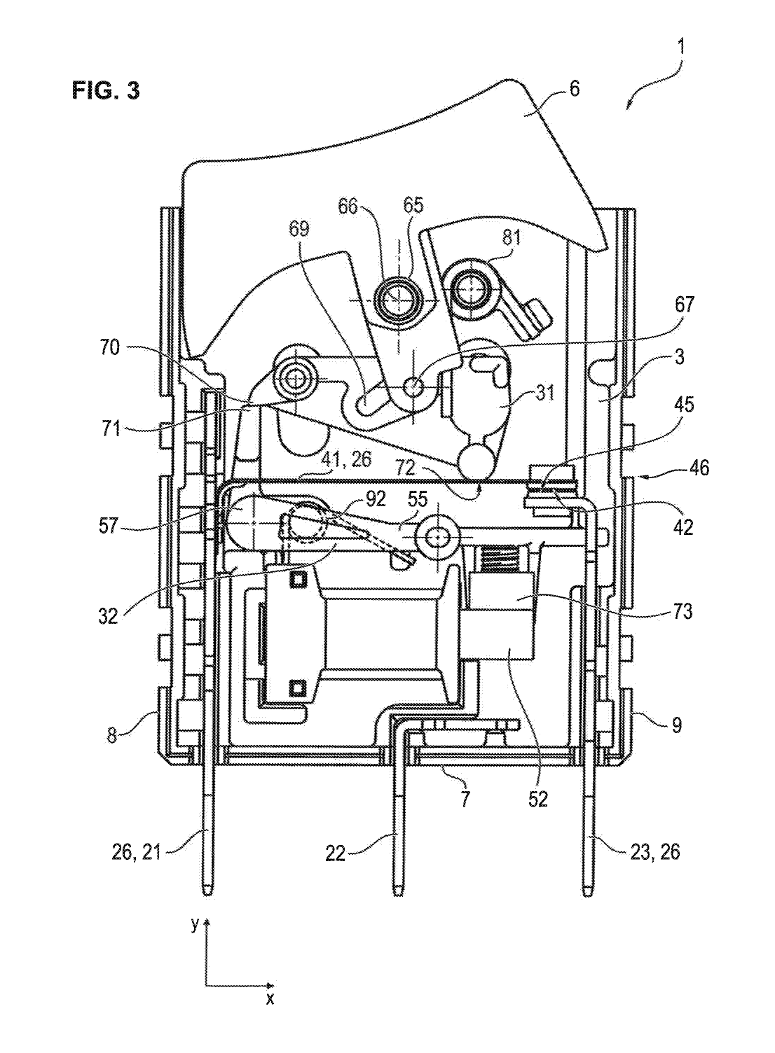

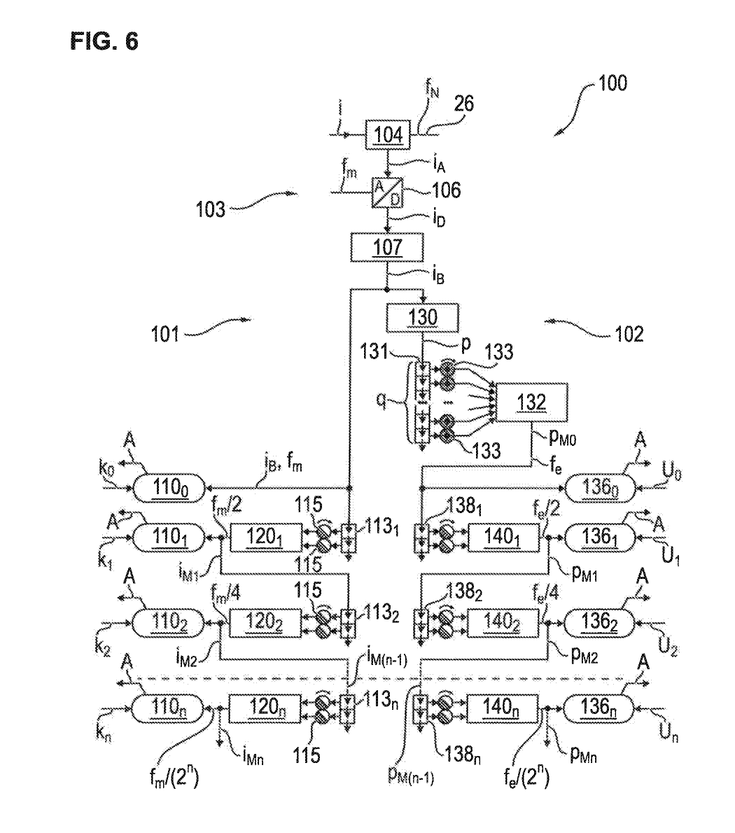

The contact rails 21 and 23 are used to make contact with a load circuit 26 to be monitored (FIGS. 3, 6). The contact rail 22 acts as a printed circuit board connection for the voltage supply for the tripping electronics 25 and the electromagnet 24.

The circuit breaker 1 furthermore has a tripping mechanism 30 for operation and tripping. The tripping mechanism 30 in turn has a switching lever 31, a tripping lever 32 and a plunger 33, in addition to the switching rocker 6.

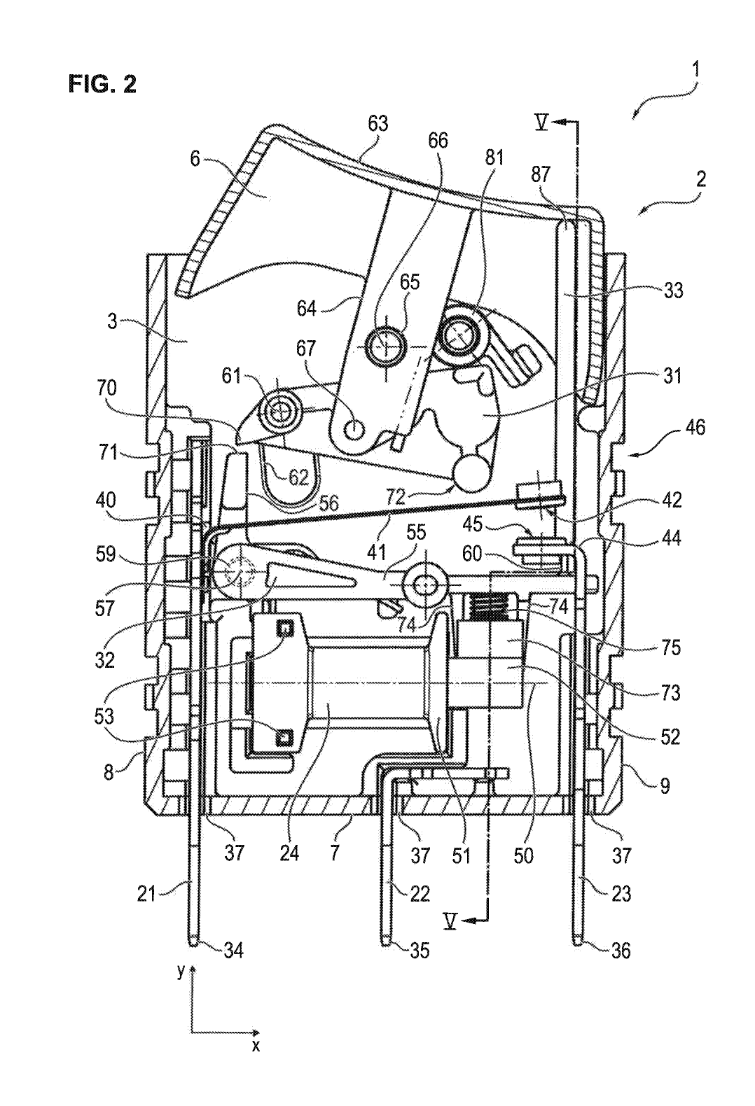

FIG. 2 shows a sectioned side view of the circuit breaker 1 in an assembled state. For orientation, a longitudinal direction Y, which is parallel to the side walls 8, 9, and a lateral direction X, which is directed from the side wall 8 to the side wall 9, are indicated here.

As can be seen from FIG. 2, in their main area extent, the contact rails 21, 22 and 23 are each aligned approximately parallel to the side walls 8 and 9, and therefore approximately at right angles to the area extent of the printed circuit board 20.

In this case, the contact rails 21 and 23 are each arranged in the immediate vicinity of one of the side walls 8 or 9, while the contact rail 22 is arranged approximately centrally between the two other contact rails 21, 23. For connection purposes, each of the contact rails 21, 22, 23 has a free end 34, 35, 36 which is in each case passed to the outside through a corresponding slot 37 in the rear wall 7. In the assembled state, each slot 37 is also closed by one of the pins 14, on the side facing the housing cover 4.

A contact spring 41, which is in the form of a leaf spring, projects approximately at right angles and once again has a contact surface 42 at the free end, is fitted to the contact rail 21 in the area of its fixed end 40, which is remote from the free end 34.

A contact surface 45, which likewise projects approximately at right angles and corresponds to the contact surface 42, is integrally formed on the contact rail 23, at the corresponding fixed end 44. The assembly which is formed from the contact spring 41, the contact surface 42 and the contact surface 45 is referred to in the following text as the switching contact 46.

The contact spring 41 extends approximately in the lateral direction X over the housing width, such that the contact surfaces 42 and 45 can be brought into contact, in order to reversibly close the load circuit 26.

The electromagnet 24 is arranged between the two contact rails 21 and 23, and the longitudinal axis 50 of its coil former 51 is directed approximately along the lateral direction X, that is to say in the longitudinal extent of its magnet core 52. The electromagnet 24 is soldered onto the printed circuit board 20 by means of solder contacts 53. The magnet core 52 projects out of the coil former 51 on its side facing the side surface 9.

Seen in the longitudinal direction Y, the tripping lever 32 is arranged between the electromagnet 24 and the contact spring 41. The tripping lever 32 has an approximately rectangular shape with a long limb 55 (approximately in the lateral direction X) and a short limb 56 (approximately in the longitudinal direction Y). The point where the two limbs 55, 56 meet is referred to in the following text as the knee 57. In the area of the knee 57, the tripping lever 32 is borne such that it can pivot on a pin 59 (shown by dashed lines) on the housing 2.

The plunger 33 is fitted to the long limb 55 via a film hinge 60, such that it can pivot, at its end remote from the knee 57. The plunger 33 extends in the longitudinal direction Y, as far as the switching rocker 6, starting from the long limb 55.

Seen in the longitudinal direction Y, the switching lever 31 is arranged above the contact spring 41. It is formed by an essentially approximately triangular, rigid part, which is guided by a pin 61 in an elongated hole guide 62 in the housing 2.

The switching rocker 6 has a body 63 in the form of a shell, as well as a shaft 64 which projects into the housing 2. The switching rocker 6 is borne on a pin 66 on the housing 2, such that it can pivot, by means of a bushing 65 in the shaft 64.

The switching rocker 6 is coupled to the switching lever 31 via a pin 67, which is arranged at the free end of the shaft 64 and engages in a guide 69 (FIG. 3), which is roughly in the form of a hockey stick, on the switching lever 31. The guide 69 is optionally in the form of a groove or elongated hole. Furthermore, the switching rocker 6 corresponds with the tripping lever 32 via the plunger 33.

The switching lever 31 once again acts on the one hand by means of a holding tab 70 with a holding shoulder 71 on the short limb 56 of the tripping lever 32. On the other hand, the switching lever 31 acts on the contact spring 41 via an effective surface 72.

The tripping lever 32 corresponds with the magnet core 52 of the electromagnet 24 via a magnet yoke 73, which is snapped thereon by means of two latching brackets 74, and is sprung by means of a compression spring 75, which is clamped in between the magnet yoke 73 and the tripping lever 32.

FIG. 2 shows the circuit breaker 1 with its switching rocker 6 in an OFF position. In the OFF position, the switching rocker 6 is prestressed by the spring force of a spring clip 81 in the tilted position illustrated in FIG. 2.

In the OFF position, the switching lever 31 is released, that it to say it does not act either on the contact spring 41 or on the tripping lever 32. The contact spring 41 is in a rest position, in which the contact between the contact surfaces 42 and 45 is interrupted.

In the OFF position, the switching rocker 6 furthermore presses the plunger 33 downward by acting on the free plunger end 87 in the longitudinal direction Y, thus bringing the magnet yoke 73 into contact with the magnet core 52.

When current is passed through the electromagnet 24 via the tripping electronics 25, then the magnet yoke 73 and the tripping lever 32 are held by magnetic force from the electromagnet 24 in the position illustrated in FIG. 2. If the switching rocker 6 is now tilted to an ON position as illustrated in FIG. 3, then the holding tab 70 on the switching lever 31 first of all strikes the holding shoulder 71 on the tripping lever 32. As a result of the two-point bearing on the holding shoulder 71 and the pin 67, which is inserted in the guide 69, the switching lever 31 is pivoted, the switching rocker 6 being tilted further (in the clockwise direction as shown in FIG. 3). Its effective surface 72 thus strikes the contact spring 41 and pushes it downward in the longitudinal direction Y until contact is made between the contact surfaces 42 and 45. In this state, the load circuit 26 is closed via the contact rails 21 and 23 and via the contact spring 41.

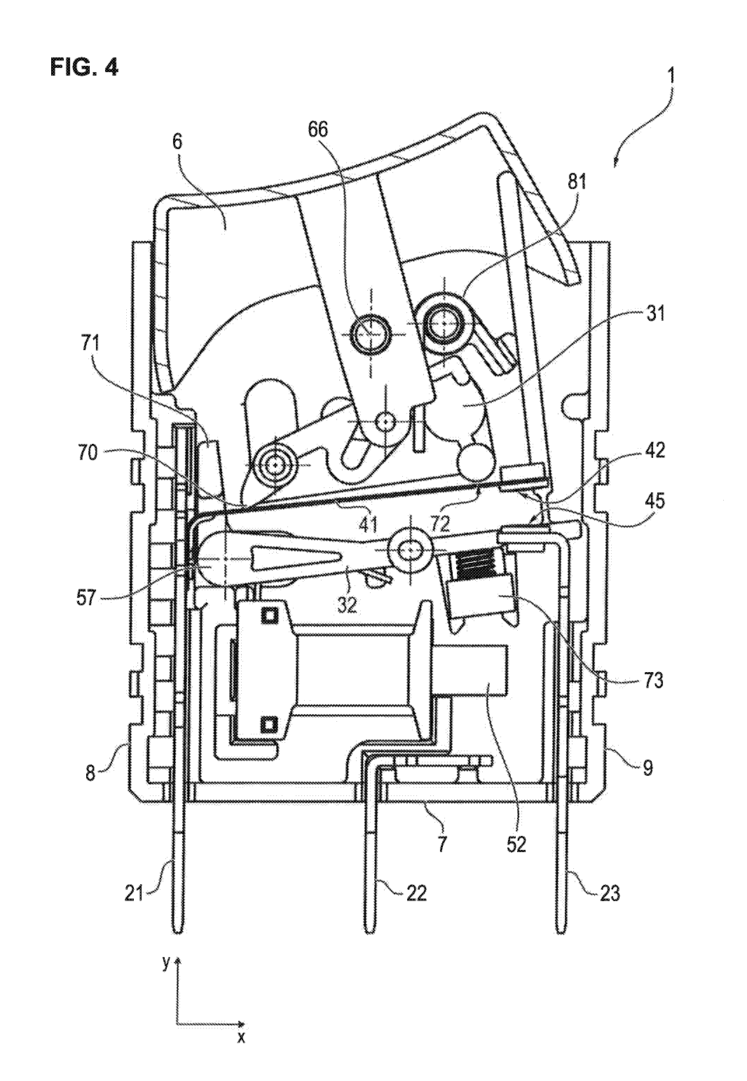

When tripping occurs, the electromagnet 24 is deactivated by the tripping electronics 25, that is to say the current fluid is disconnected, and the magnet yoke 73 is therefore released. As a consequence of this, the tripping lever 32 is pivoted in the counterclockwise direction about the knee 57 to the position illustrated in FIG. 4, under the influence of a spring clip 92.

In consequence, the holding tab 70 on the switching lever 31 is decoupled from the holding shoulder 71 on the tripping lever 32. Because of the lack of mutual coupling, the switching lever 31 is pivoted in the counterclockwise direction to the position illustrated in FIG. 4, in which it once again releases the contact spring 41, as a result of which the contact surfaces 42 and 45 are separated. This tripping mechanism also takes place in particular when the switching rocker 6 is blocked in the ON position as shown in FIG. 4 (freetripping).

If the switching rocker 6 is not blocked in the ON position, it tilts back to the OFF position, as shown in FIG. 2, under the influence of the spring clip 81.

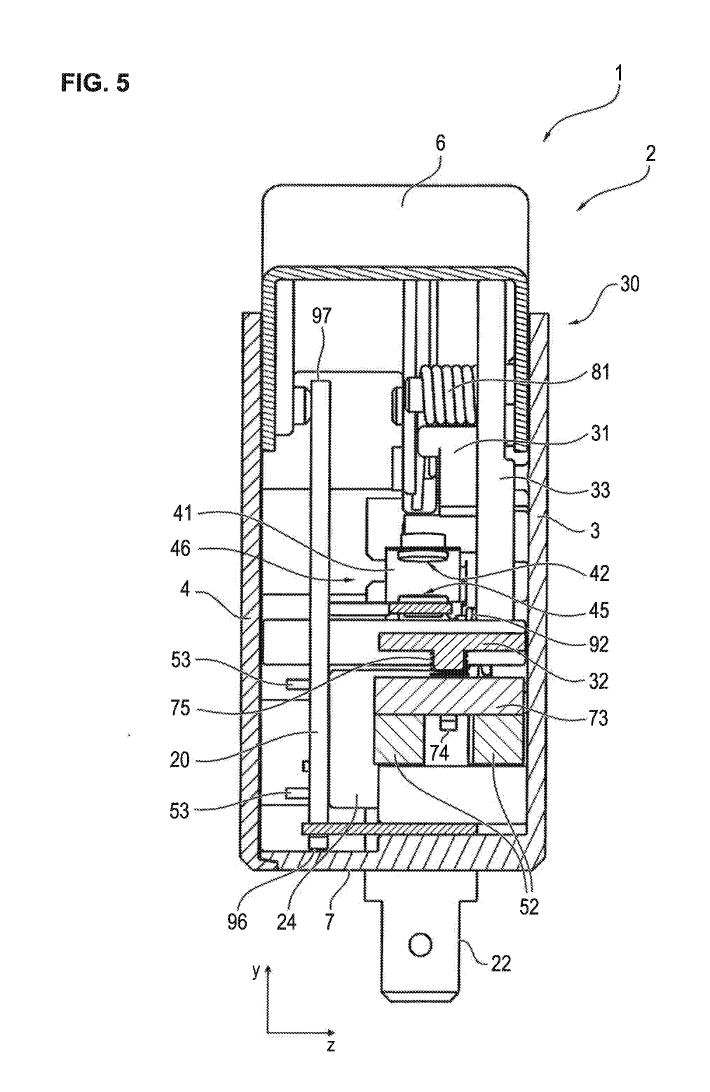

FIG. 5 shows an angled cross section taken along the line V-V of the circuit breaker 1 as shown in FIG. 2. As can be seen from this illustration, a first edge 96 of the printed circuit board 20 rests approximately on the rear wall 7, and an edge 97 of the printed circuit board 20 opposite this projects into the switching rocker 6. As can likewise be seen from FIG. 5, the moving parts of the tripping mechanism 30, specifically the switching rocker 6, the switching lever 31 and the tripping lever 32 together with the plunger 33 including the associated springs 81 and 82, are all arranged on the side of the printed circuit board 20 facing away from the housing cover 4.

The printed circuit board 20 is assembled outside the housing 2 with the contact rails 21, 22, 23 of the contact springs 41 and the electromagnet 24 to form a fixed cohesive preassembled assembly. This preassembled assembly, which comprises all the parts of the circuit breaker 1 which carry current or voltage, is inserted as an entity into the housing trough 3 with the tripping mechanism 30 inserted therein. All that is then necessary is to clip the housing cover 4 onto the housing trough 3, in order to complete the assembly process—which is therefore not complex overall.

In the illustrated exemplary embodiment, the tripping electronics 25 are formed at least essentially by a microcontroller. A control program 100, which is illustrated in more detail in FIG. 6, is implemented in the software form in the microcontroller and automatically carries out a method, as will be described in more detail in the following text, for tripping the circuit breaker 1 in the event of a short circuit or overload.

The control program 100 comprises two parallel functional sections, specifically a (short-circuit tripping) section 101 and an (overload tripping) section 102, which branch off from a common section 103.

First of all the (load) current level i in the load circuit 26 is determined as an input signal by means of a current sensor 104 in the common section 103. The current sensor 104 (for example formed by a shunt or a current transformer) emits as an output signal an analogue current measurement signal i_{A} in the form of a voltage which is proportional to the current level, to a downstream analogue/digital (A/D) converter 106. The analogue current measurement signal i_{A} is converted to a digital current measurement signal i_{D} in the A/D converter 106, which is preferably an integral component of the microcontroller, in time with a (measurement) clock frequency fₘ with a resolution of nm bits (in this case nm=8).

The current measurement signal i_{D} is produced such that:

i_{D}=0 corresponds to a measured current level i=−C·I_{N},

I_{D}=2^{nm-1} corresponds to a measured current level i=0, and

I_{D}=2^{nm} corresponds to a measured current level i=+C·I_{N}.

I_{N} in this case denotes the rated current level of the circuit breaker 1. The constant C is fixed at values between about 3 and 20, for example at C=15, depending on the tripping sensitivity of the circuit breaker 1.

The circuit breaker 1 is intended primarily for monitoring an alternating-current load circuit. The measurement clock frequency fₘ is therefore set to a multiple of, in particular to 20 times, the normal mains frequency f_{N} (that is to say to fm=1 kHz when the mains frequency is f_{N}=50 Hz). In addition to this, the circuit breaker 1 may, however, be used to monitor a direct-current load circuit without having to modify the control program 100 for this purpose.

A digital (current) magnitude signal i_{B} which corresponds in essence to the absolute magnitude of the load current level i is produced by a magnitude module 107, which in software terms is connected downstream from the A/D converter 106, using the equation

i_{B}=|i_{D}−2^{nm-1}|

The magnitude signal i_{B} flows as an input variable into the section elements 101 and 102 of the control program 100.

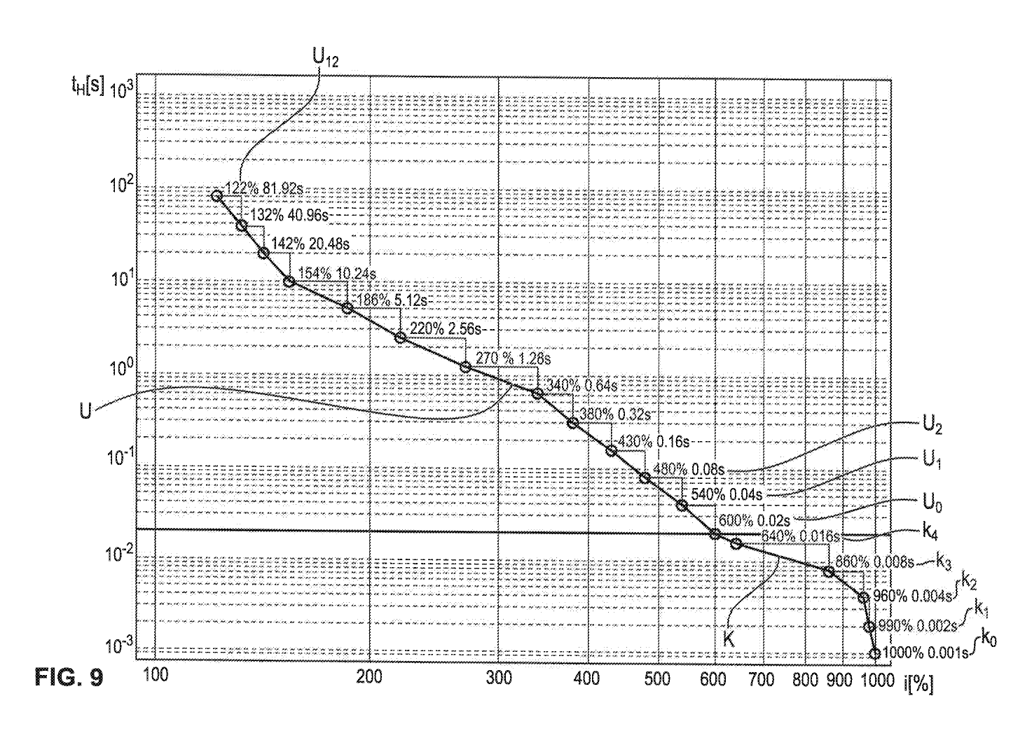

In a zero test stage of the short-circuit tripping section 101, the sample value of the magnitude signal i_{B}, determined in each measurement clock cycle, is compared in a comparison module 110₀ at the clock frequency fₘ with a discrete characteristic point k₀ on a stored (short-circuit tripping) characteristic K (FIG. 9). The comparison module 110₀ remains inactive provided that the sample value of the magnitude signal i_{B} does not exceed the characteristic point k₀ (i_{B}≦k₀). Otherwise (i_{B}>k₀), the comparison module 110₀ outputs a tripping signal A, on the basis of which the current flow through the electromagnet 24 is interrupted, and the circuit breaker 1 is therefore tripped.

The current measurement signal i_{D}), to be precise the magnitude signal i_{B}, therefore contains digital sample values of the current level i at discrete sampling times, which follow one another at a time interval of fₘ⁻¹.

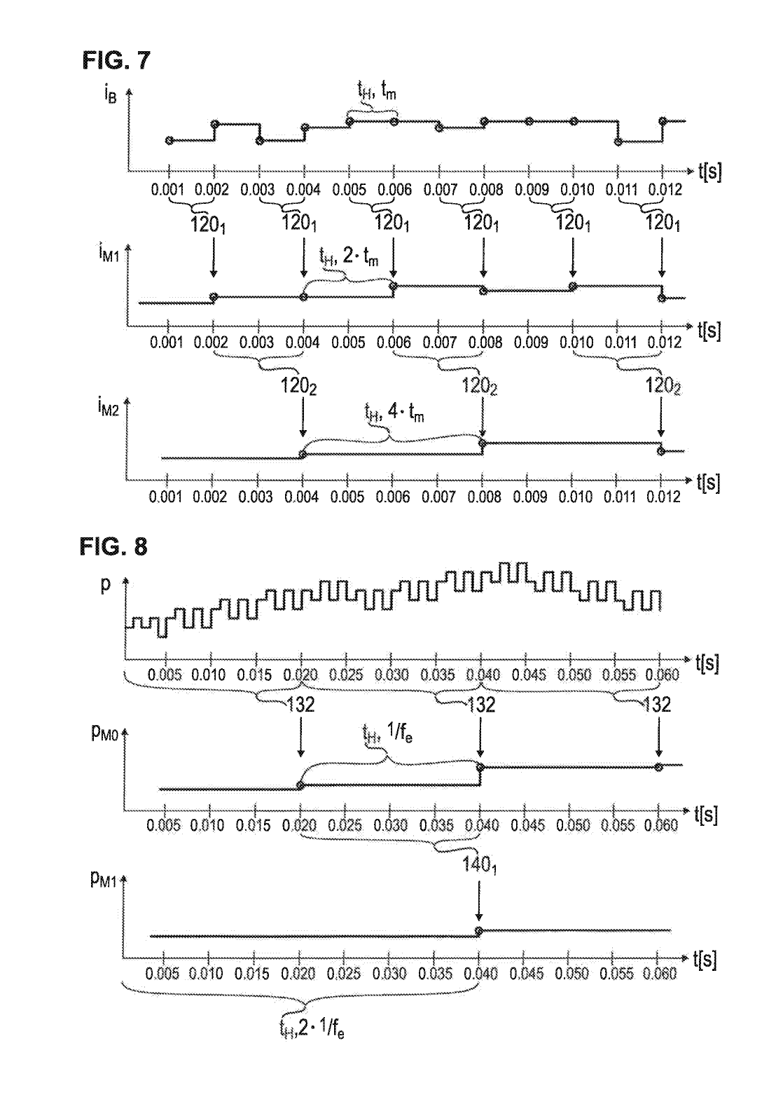

The characteristic point k_{c}, reflects the so-called immediate tripping threshold. The value of the characteristic point k₀ is a measure of the maximum permissible overcurrent level averaged over a holding time t_{H} (FIG. 9). In this case, the holding time t_{H} corresponds to the reciprocal of the clock frequency fₘ or the simple (measurement) clock time tₘ (FIG. 7) (t_{H}=tₘ=fₘ⁻¹; in this case t_{H}=0.001 s). A single measured value of the magnitude signal i_{B} which exceeds the characteristic point k₀ is therefore sufficient to trip the circuit breaker 1.

In a—subsequently—first test step in the short-circuit tripping section 101, the respectively determined sample value of the current magnitude i_{B} is written to a first (FIFO, first-in-first-out) memory 113₁ with a total of (in this way by way of example: two) memory locations, at the clock frequency fₘ, that is to say in each measurement clock cycle.

Whenever a number of measurement clock cycles corresponding to the number of memory locations has passed—indicated by the clock symbols 115—a sum module 120₁ forms a rounded mean value i_{M1} from the sample values of the magnitude signal i_{B} stored in the memory 113₁. If there are two memory locations, the mean value i_{M1} is therefore formed at half the clock frequency fₘ/2=500 Hz. A sample value of the magnitude signal i_{B} which is stored in the memory 113₁ is therefore only ever taken into account once in the averaging process. In simple terms, the memory 113₁ is only ever evaluated when it has been completely filled with new sample values of the magnitude signal i_{B}.

The mean value i_{M1} is supplied as a test variable to a downstream comparison module 110₁. The comparison module 110₁ in turn compares this mean value i_{M1} with an associated characteristic point k₁ on the characteristic K and—analogously to the comparison module 110₀—outputs the tripping signal A if the value of the mean value i_{M1} exceeds the characteristic point k₁ (i_{M1}>k₁). The characteristic point k₁ is a measure of the average maximum permissible overcurrent level over a holding time t_{H}, which corresponds to twice the clock time tₘ(t_{H}=2·tₘ=2·fₘ⁻¹; in this case t_{H}=0.002 s).

The mean value i_{M1} in the first test step is supplied as an input variable to a second test step which, analogously to the first test step, has a further (first-in-first-out) memory 113₂, a further sum module 120₂ and a further comparison module 110₂. The operation of the second test step is also the same as that of the first test step, with the difference that the mean value i_{M1} from the first test step is supplied to the memory 113₂, rather than the magnitude signal i_{B}, and that a mean value i_{M2}, produced by the sum module 120₂, is produced at the clock frequency f_{M}/4, that is to say fₘ/4=250 Hz. A characteristic point k₂ which is associated as a tripping criterion with the comparison module 110₂ is therefore a measure of the maximum overcurrent level on average over a holding time t_{H} which corresponds to four times the clock time tₘ(t_{H}=4·tₘ=4·fₘ⁻¹; in this case t_{H}=0.004 s).

The second test step is followed in cascade form by one or more n-th order (n=3, 4, . . . ) further test steps, whose configuration and function once again correspond to those of the second test step, and which are each formed by a (first-in-first-out) memory 113ₙ, a further sum module 120ₙ and a further comparison module 110ₙ. As an input signal, the memory 113ₙ in this case always receives the mean value i_{M(n-1)} from the directly preceding (n−1)th test step. The sum module 120ₙ in the n-th test step always produces a mean value i_{Mn} at the clock frequency divided by 2ⁿ, that is to say fₘ/2ⁿ, and this mean value is compared with a characteristic point k_{N} in the comparison module 110ₙ. The characteristic point kₙ is a measure of the maximum overcurrent level on average over a holding time t_{H} which corresponds to 2ⁿ times the clock time tₘ(t_{H}=2ⁿ·tₘ=2ⁿ·fₘ⁻¹).

The principle of this cascade-like averaging process is illustrated once again in FIG. 7, in which the profile of the magnitude signal i_{B} and of the mean values i_{M1} and i_{M2} is compared over the time t in synchronous graphs, which are arranged one above the other. As can be seen directly from this illustration, the cascade-like averaging process results in the hierarchically successive test steps checking for changes in the load current on respective timescales which increase exponentially with the order of the step. A measure for the timescale associated with the respective test set is in this case the holding time t_{H} of the respective test step:

n-th test step(n=0, 1, 2, . . . ): t_{H}=2ⁿ·tₘ=2ⁿ·fₘ⁻¹

As shown in FIG. 6, a square signal p, where p=i_{B}·i_{B}, is first of all calculated from the magnitude signal i_{B} in a squaring module 130 in the overload tripping section element 102, as a measure of the power of the load current.

This square signal p is read at the clock frequency fₘ to a (first-in-first-out) memory 131 in a zero test step of the section element 102. The memory 131 has a total number q of memory locations—once again for use of the circuit breaker 1 for protection of an alternating-current load circuit—, which corresponds to the ratio of the clock frequency f, to the normal mains frequency f_{N} or to a multiple thereof:

q=j·fₘ/f_{N} where j=1, 2, 3, . . .

In particular, the memory 131 has q=20 memory locations for a mains frequency of f_{N}=50 Hz and a clock frequency of fₘ=1 kHz.

After a number of measurement clock cycles corresponding to the number q—indicated by the clock symbols 133—a sum module 132 which follows the memory 131 always calculates a rounded mean value p_{M0} from the values of the square signal p stored in the memory 131. The mean value p_{M0} in this case represents a measure of the root mean square power of the load current. If the memory 131 has 20 memory locations, the mean value p_{M0} is formed at a clock frequency fₑ=f_{N}= 1/20·fₘ, which corresponds to the mains frequency f_{N}. A value of the square signal p stored in the memory 131 is in consequence once again only ever taken into account once in the averaging process.

The mean value p_{M0} is compared in a downstream comparison module 136₀ with a characteristic point u₀ on a stored (overload-tripping) characteristic U (FIG. 9), with the comparison module 136₀ producing the tripping signal A if the value of the mean value p_{M0} exceeds the square of the characteristic point u₀ (p_{M0}>u₀²). The square u₀² of the characteristic point u₀ therefore represents a measure of the maximum permissible root mean square power of the load current.

Analogously to the section element 101, hierarchically successive test steps are also provided in the section element 102, whose design and function correspond to those of the corresponding test steps in the section element 101. Each of these test steps comprises:
a (first-in-first-out) memory 138ₙ with two memory locations, which are supplied as an input variable with the mean value p_{M(n-1)} from the respectively previous test step,
a sum module 140ₙ, which calculates a mean value p_{Mn} of the values contained in the memory 138ₙ at ½ₙ-times the clock frequency ½ⁿ·fₑ, and
a comparison module 136ₙ, which compares this mean value p_{Mn} with the square uₙ² of an associated characteristic point uₙ, and produces the tripping signal A if p_{Mn}>uₙ².

The numerical variable n=1, 2, 3, . . . in this case once again denotes the hierarchical order of the respective test step.

In one exemplary embodiment of the control program 1, the section element 101 has five test steps (n=0, 1, . . . ,4) while the section element 102 has thirteen test steps (n=0, 1, . . . ,12).

Analogously to FIG. 7, FIG. 8 shows the time profile of the square signal p and of the mean values p_{M0} and p_{M1} in the form of a comparison. As can be seen from this illustration, the test steps in the second section element 102 test for changes in the power of the load current—with the exception of the zero test step—once again using time scales which grow exponentially with the step order:

n-th test step(n=1, 2, . . . ): t_{H}=2ⁿ·fₑ⁻¹

The modules 107, 110ₙ (n=0, 1, 2, . . . ), 120ₙ (n=1, 2, . . . ), 130, 132, 136ₙ (n=0, 1, 2, . . . ), and 140ₙ (n=1, 2, . . . ) are software modules in the control program 100. The (first-in-first-out) memories 113ₙ (n=1, 2, . . . ), 131 and 138ₙ (n=1, 2, . . . ) are preferably software-allocated (that is to say reserved) areas in a common main memory in the microcontroller which runs the control program 100.

FIG. 9 shows the characteristics K and U plotted on a log-log graph against the holding time t_{H} (in this case plotted on the ordinate). The current level i is plotted as a percentage of the rated current level I_{N} on the circuit breaker 1 on the abscissa of the graph.

Corresponding to the respective number of test steps, the characteristic K comprises four characteristic points k₀, k₁, . . . , k₄, while the characteristic U is formed from thirteen characteristic points u₀, uᵢ, . . . , u₁₂. As can be seen from FIG. 9, the characteristics K and U cover a holding time interval of 10⁻³ s≦t_{H}≦10² s, without any overlap. The characteristic K in this case defines the tripping behavior of the circuit breaker 1 on timescales below the reciprocal of the mains frequency (t_{H}<f_{N}⁻¹=20 ms), while the characteristic U defines the tripping behavior of the circuit breaker 1 on timescales above the reciprocal of the mains frequency (t_{H}≧f_{N}⁻¹=20 ms).

The current values (tripping values) of the characteristic points kₙ and uₙ may be chosen freely—contrary to the example shown in FIG. 9. However, the characteristic points kₙ and uₙ are expediently chosen such that the characteristics K and U each fall strictly monotonally, as a result of which the holding time t_{H} is always shorter the higher the current value of the respective characteristic point kₙ or uₙ.

In principle, the number of characteristic points kₙ and uₙ can also be chosen freely for each of the characteristics K and U. The number of test steps in the branch elements 101 and 102 must in this case always be matched to the number of characteristic points kₙ and uₙ on the respectively associated characteristic K or U, with the respectively associated holding time t_{H} for each characteristic point kₙ or uₙ corresponding to a test step in the section element 101 or 102, respectively. However, alternatively, it is also feasible
to provide more test steps within a section element 101 or 102 when the associated characteristic has characteristic points kₙ or uₙ, and/or
to choose at least some of the characteristic points kₙ and/or uₙ such that the holding time t_{H} associated with these characteristic points kₙ or uₙ does not match the holding time t_{H} associated with a test step.

In these situations, rather than supplying the test steps with the characteristic points kₙ or uₙ, they are supplied with threshold values which are derived by interpolation or extrapolation from the characteristic points kₙ or uₙ on the basis of the holding times t_{H} associated with the test steps.

In an alternative embodiment of the invention, the exponential increase in the holding time t_{H} as the step order n rises can also be varied by defining the successive memories 113ₙ (n=1, 2, . . . ) or 138ₙ (n=1, 2, . . . ) to have a varying number of memory locations within the same section element 101 or 102.

By virtue of its design, the circuit breaker 1 has a passive undervoltage tripping function, with the tripping mechanism 30 necessarily being tripped when the voltage which is present between the contact rails 21 and 22 is no longer sufficient to supply enough electrical energy to the electromagnet 24 and/or the tripping electronics 25. In particular, this function can be used to trip the circuit breaker 1 by remote control, by means of a switch connected downstream from the contact rail 22.

Furthermore, optionally, the circuit breaker 1 has an active overvoltage tripping function which, in particular, is implemented in the form of software in an undervoltage tripping block (which is not illustrated) in the control program 100. For the purposes of this active undervoltage tripping, the control program 100 continuously and in parallel with the running of the program part illustrated in FIG. 6, records the magnitude (the root mean square magnitude in the case of an AC voltage) of the electrical voltage which is present between the contact rails 21 and 22, and compares the recorded voltage magnitude with a stored threshold value. In this case, the control program 100 produces the tripping signal A if the recorded voltage magnitude undershoots the threshold value.

1. An electronic circuit breaker, comprising:
an insulating housing;
a switching contact for reversible contact-making in a load circuit to be monitored;
a tripping magnet configured to act on said switching contact via a tripping mechanism;
tripping electronics for operation of said tripping magnet; and
a printed circuit board having firmly mounted thereon said switching contact, said tripping magnet, and said tripping electronics and forming therewith a preassembled assembly, with said preassembled assembly configured for insertion into, or inserted in, said housing as a unit.

2. The circuit breaker according to claim 1, which further comprises contact rails for connection of said switching contact, of said tripping magnet, and of said tripping electronics to external power lines mounted on said printed circuit board within said preassembled assembly.

3. The circuit breaker according to claim 1, wherein said housing is configured with a housing trough and a flat housing cover for closing said housing trough, and said printed circuit board extends substantially parallel to said housing cover in an assembled state of the circuit breaker.

4. The circuit breaker according to claim 3, wherein said printed circuit board is disposed immediately adjacent said housing cover in an interior of said housing, in a final assembled state of the circuit breaker.

5. The circuit breaker according to claim 1, wherein said tripping magnet is a holding magnet.

6. The circuit breaker according to claim 1, wherein said tripping magnet has a longitudinal axis aligned substantially perpendicularly to a movement direction of said switching contact.

7. The circuit breaker according to claim 6, wherein said longitudinal axis of said tripping magnet is aligned substantially perpendicularly to a longitudinal direction of said housing.

8. The circuit breaker according to claim 1, wherein said tripping magnet has a longitudinal axis aligned substantially perpendicularly to a longitudinal direction of said housing.
